(19) United States
(12) Patent Application Publication
(10) Pub. No.: US 2025/0119846 A1
(43) Pub. Date: Apr. 10, 2025

(54) METHOD AND APPARATUS FOR BEAM INFORMATION REPORTING

(71) Applicant: Nokia Technologies Oy, Espoo (FI)

(72) Inventors: Tero HENTTONEN, Espoo (FI); Samuli Heikki TURTINEN, Oulu (FI); Chunli WU, Beijing (CN); Samantha CAPORAL DEL BARRIO, Aalborg (DK)

(21) Appl. No.: 18/729,402

(22) PCT Filed: Jan. 18, 2022
(86) PCT No.: PCT/CN2022/072617

§ 371 Date: Jul. 16, 2024

(51) Int. Cl. H04W 52/36; H04W 52/42

(52) U.S. Cl. CPC H04W 52/365; H04W 52/367; H04W 52/42

(57) ABSTRACT

Example embodiments of the present disclosure relate to a method, apparatus and computer readable storage medium for beam information reporting. In example embodiments, the device obtains beam information via measurement. Moreover, the device sends a power headroom report, PHR, to a network node. The PHR comprises a bitmap indicating whether beam information for a plurality of serving cells is present.

### FIELD

Example embodiments of the present disclosure generally relate to the field of communications, and in particular, to a method, apparatus and computer readable storage medium for beam information reporting.

### BACKGROUND

In order to assist an evolved NodeB (eNodeB) to schedule transmission resources to different user device in an appropriate way, it is important for the user device to report available power headroom to the eNodeB. This mechanism may be called power headroom reporting (PHR). The eNodeB may use the power headroom reports to determine transmission resources to be used by the user device. PHR helps to avoid allocating unnecessary transmission resources to the user device and avoids waste of resource due to allocation. User device is also called user equipment (UE) in the current disclosure.

The PHR may comprise power headroom (PH) information and maximum permission exposure (MPE) information for a serving beam of a serving cell. However, if quality of the serving beam is not good enough, it is necessary to report beam information for one or more further beams for a plurality of serving cells to improve transmission efficiency.

For fifth generation technology standard for broadband cellular networks (5G) or 5G beyond, one user device may support connecting to multiple serving cells, and each cell may support multiple beams. In order to improve the quality of communication, the user device needs to measure reference signal (RS) and reports the RS measured to the serving cell(s). But, how to efficiently report beam information for each serving cell is an open issue be addressed.

### SUMMARY

In general, example embodiments of the present disclosure provide a method, apparatus and computer readable storage medium for beam information reporting.

In a first aspect, a method is provided. In this method, a user device obtains beam information via measurement. Moreover, the user device sends a power headroom report, PHR, to a network node. The PHR comprises a bitmap indicating whether beam information for a plurality of serving cells is present.

In some example embodiments, when a bit in the bitmap indicates that beam information is present for a first serving cell of the plurality of serving cells, the PHR further comprises first beam information of the first serving cell, wherein the first beam information comprises an extension, E, bit indicating whether second beam information is present for the serving cell.

In some example embodiments, when a bit in the bitmap indicates that beam information is present for a first serving cell of the plurality of serving cells, the beam information of the first serving cell further comprises a bit indicating whether and/or how much power management maximum power reduction, P-MPR, is required by the user device when using a beam of the first serving cell.

In some example embodiments, the user device may receive, from the network node, a configuration of the beam information reporting, wherein the configuration comprises a maximum number of beams to be reported.

In some example embodiments, the user device may trigger the sending of the PHR when maximum permission exposure, MPE, for a beam is lower than a threshold amount or better than MPE for a serving beam, and/or quality of a beam is higher than threshold quality or better than quality of the serving beam.

In some example embodiments, the user device may use a logical channel identity, LCID, for sending the PHR when beam information is present for at least one of the plurality of serving cells. In a second aspect, a method is provided. In this method, a network node receives a power headroom report, PHR from a user device. The PHR comprises a bitmap indicating whether beam information for a plurality of serving cells is present. Moreover, the network node obtains beam information for the plurality of serving cells based on the PHR.

In some example embodiments,, when a bit in the bitmap indicates that beam information is present for a first serving cell of the plurality of serving cells, the PHR further comprises first beam information of the first serving cell, wherein the first beam information comprises an extension, E, bit indicating whether second beam information is present for the serving cell.

In some example embodiments, when a bit in the bitmap indicates that beam information is present for a first serving cell of the plurality of serving cells, the beam information of the first serving cell further comprises a bit indicating whether and/or how much power management maximum power reduction, P-MPR, is required by the user device when using a beam of the first serving cell.

In some example embodiments, the network node may send, to the user device, a configuration of the beam information reporting, wherein the configuration comprises a maximum number of beams to be reported.

In some example embodiments, the network node may send, to the user device, a configuration for conditions to trigger sending of the PHR when maximum permission exposure, MPE, for a beam is lower than a threshold amount or better than MPE for a serving beam, and/or quality of a beam is higher than threshold quality or better than quality of the serving beam.

In some example embodiments, the network node may send, to the user device, a configuration for using a logical channel identity, LCID, for sending the PHR when beam information is present for at least one of the plurality of serving cells. In a third aspect, an apparatus is provided which comprises a transceiver and at least one processor. The at least one processor is configured to obtain beam information via measurement. Moreover, the transceiver is configured to send a power headroom report, PHR, to a network node. The PHR comprises a bitmap indicating whether beam information for a plurality of serving cells is present.

In a fourth aspect, an apparatus is provided which comprises a transceiver and at least one processor. The transceiver configured to receive a power headroom report, PHR from a user device. The PHR comprises a bitmap indicating whether beam information for a plurality of serving cells is present. Moreover, the at least one processor is configured to obtain beam information for the plurality of serving cells based on the PHR.

In a fifth aspect, there is provided a computer readable storage medium comprising program instructions stored thereon. The instructions, when executed by a processor of a device, cause the device to perform the method according to the first or second aspect.

In this way, flexible and efficient beam information reporting is achieved by adding a bitmap in the PHR to indicate whether beam information for a plurality of serving cells is present. As such, it is allowed to avoid unnecessary signaling overhead and power consumption.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a signaling flow between the devices according to some example embodiments of the present disclosure;

FIG. 3 illustrates an example structure for PHR containing beam information according to some example embodiments of the present disclosure;

FIG. 4 illustrates an example process for beam information reporting according to some example embodiments of the present disclosure;

FIG. 5 illustrates a flowchart of an example method according to some example embodiments of the present disclosure;

FIG. 6 illustrates a flowchart of an example method according to some other example embodiments of the present disclosure;

FIG. 7 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “beam” may refer to a communication resource. Different beams may be considered as different resources. A beam may also be represented as a spatial filter. A technology for forming a beam may be a beamforming technology or another technology. The beamforming technology may be specifically a digital beamforming technology, analog beamforming technology, or a hybrid digital/analog beamforming technology. A communication device (including the terminal device and the network device) may communicate with another communication device through one or more beams. One beam may include one or more antenna ports and be configured for a data channel, a control channel, or the like. One or more antenna ports forming one beam may also be considered as an antenna port set. A beam may be configured with a set of resource, or a set of resource for measurement. For example CSI resource configuration which may include a CSI-ResourceConfigId and CSI-RS resource set.

As used herein, the term “network device” or “network node” refers to a device via which services can be provided to a terminal device in a communication network. As an example, the network device may comprise a base station. As used herein, the term “base station” (BS) refers to a network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “terminal device”, “user device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the user device include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

In the third generation partnership project (3GPP) radio access network (RAN) #86, further enhancements on MIMO for NR have been discussed. RAN1 has agreed to extend MPE reporting with up to 4 P-MPR values, each corresponding to a particular candidate beam, identified by either SSBRI or CRI.

In 3GPP Release 16 (Rel-16), it is agreed that the MPE reporting is included as part of the PHR media access control (MAC) control element (CE). The trigger of MPE reporting may be specified as part of the PHR procedures.

Further, in 3GPP Release 17 (Rel-17), it has been discussed that MPE reporting is added to the PHR MAC CE, extending Rel-16 MPE reporting. It is further discussed that a UE supporting Rel-17 MPE reporting should also support Rel-16 MPE reporting and the UE shall always use the Rel-17 P-MPR reporting format when the Rel-17 MPE configuration is provided.

Further, there are some discussions about the PHR content. It is discussed that UE is configured with the “MPE resource pool” (e.g. a list of SSB/CSI-RS resources used for the MPE/P-MPR reporting), and the network device can indicate how to report P-MPR in PHR for a UE with many additional beams, which requires both the P-bit and MPE fields. For beam identification, the UE needs to indicate the “MPE resource” index (i.e. the index of SSB/CSI-RS resources used for the MPE/P-MPR reporting) in the MAC CE, and for the P-MPR, the PCMAX,f.c needs to be included. But given that all of these beams are “virtual”, it seems that there is no need to include the V-bit for any of the beams.

In 3GPP Rel-17, it has been discussed the PHR MAC CE should indicate 0-4instances of “beam information”, with each “beam information” containing P-bit, 2-bit MPE field, beam identification field and P_{CMAX,f,c} field. Beam information in the current disclosure includes CSI-RS Resource Indicator (CRI) or synchronization signal (SS)/physical broadcast channel (PBCH) resource block indicator (SSBRI). For the “beam identification field”, 6 bits are initially reserved for the CRI/SSBRI (e.g., beam index) signaling as that fits the existing maximum values for SSB and CSI-RS. The CRI/SSBRI reporting field indicates a resource index configured in RRC for the MPE resource pool. It has been also discussed that the same changes need to be done for all the three different PHR formats: single-entry PHR, multi-entry PHR with max 8 cells and multi-entry PHR with max 32 cells.

Further, there are some discussions about PHR reporting for multiple Transmission Reception Point (mTRP). It is agreed in RAN1 to indicate PHR for TRP1 and TRP2 when mTRP is configured. In Rel-17, it is required for the UE to duplicate the existing PH report for each serving cell using mTRP, that is, to duplicate the fields P, PH, (MPE or R) and P_{CMAX,f,c} for each of TRP1 and TRP2. In this case, addition of mTRP-based reporting adds overhead of fixed 2 octets per serving cell with mTRP to the PHR. Combining with the MPE reporting may be done without large complexity increase.

However, if quality of the serving beam is not good enough, it is necessary to report additional beam information for one or more further beams of a serving cell to improve transmission efficiency. Moreover, encoding additional beam information for each serving cell continuously and indicating for each beam if the beam is reported or not will increase enormous overhead in case the UE decided not to report PHs for different beams for the cells, that is, when the serving beam is good enough or there is no beam of better quality to report. Besides, by now, there is no effective way to report the additional beam information for a plurality of serving cells.

Example embodiments of the present disclosure provide a scheme of beam information reporting. With the scheme, a device, such as a UE, obtains beam information via measurement. Moreover, the device sends a power headroom report, PHR, to another device, such as a network node. The PHR comprises a bitmap indicating whether beam information for a plurality of serving cells is present.

This scheme facilitate flexible and efficient beam information reporting by adding a bitmap in the PHR to indicate whether beam information for a plurality of serving cells is present. As such, it is allowed to avoid unnecessary signaling overhead and power consumption.

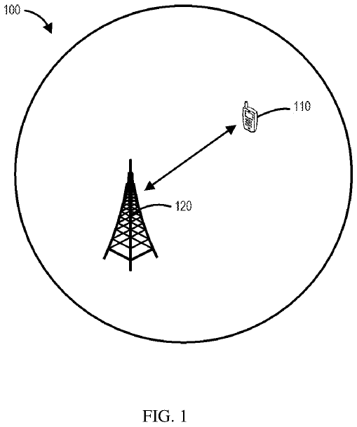

FIG. 1 shows an example environment 100 in which example embodiments of the present disclosure can be implemented.

The environment 100, which may be a part of a communication network, comprises two devices 110 and 120 communicating with each other or with other devices via each other.

The devices 110 and 120 may be implemented by any suitable devices in the communication network. In some example embodiments, the device 110 may be implemented by a terminal device and the device 120 may be implemented by a network device, or vice versa. In some other example embodiments, the devices 110 and 120 may be both implemented by terminal devices or network devices. Just for the purpose of discussion, in this example, the user device will be taken as an example of the device 110, and the network node will be taken as an example of the device 120.

It is to be understood that two devices are shown in the environment 100 only for the purpose of illustration, without suggesting any limitation to the scope of the present disclosure. In some example embodiments, the environment 100 may comprise a further device to communicate with the device 110 and the device 120.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

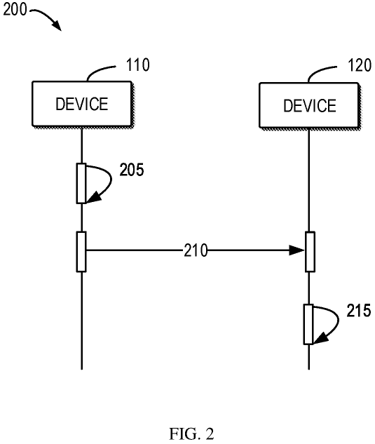

FIG. 2 shows a signaling flow 200 between the device 110 and the device 120 according to some example embodiments of the present disclosure. For the purpose of discussion, the signaling flow 200 will be described with reference to FIG. 1.

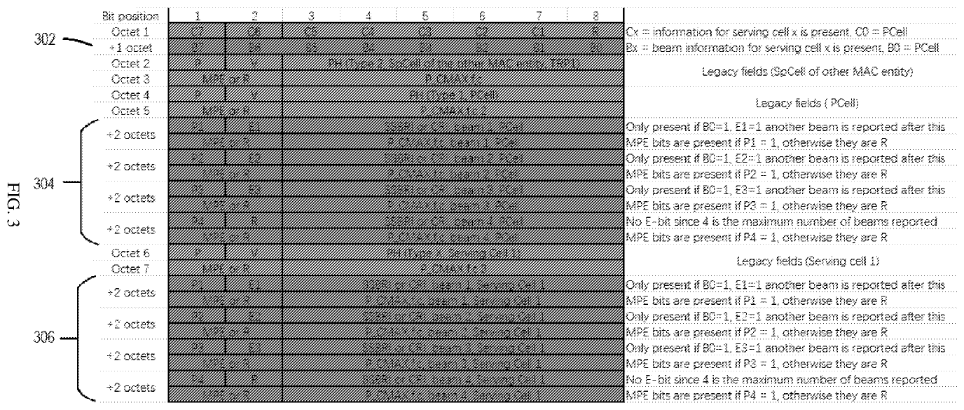

As shown in FIG. 2, the device 110 obtains (205) beam information via measurement. For example, the beam information may comprise beam identifier, MPE, and P_CMAX, Power Headroom (PH) which will be described in details with reference to FIG. 3. For example, the device 110 may obtain the beam information for a plurality of serving cells. The beam information for a serving cell of the plurality of serving cells may comprise beam information for one or more additional beams for the serving cell, except for the serving beam.

The device 110 (205) may obtain beam information via measuring the beams of each serving cell, and select one or more beams according to predefined criteria, for example over some threshold, or N best beams, wherein N is an integer.

It should be noted that the serving cells in the current disclosure may include primary cell (PCell), and/or serving cells of the master cell group (MCG) other than the PCell, secondary primary cell (SpCell), and/or serving cells of the secondary cell group (SCG) other than PSCell.

Then, the device 110 may determine how to include beam information for a plurality of serving cells into the PHR.

In some example embodiments, for the multiple entry PHR MAC CE format, a bitmap (also referred to as a Bi-bitmap) may be comprised in the PHR to indicate whether beam information for a plurality of serving cells is present. For example, the Bi-bitmap following the existing Ci-bitmap may be included to indicate if beam information for one or more additional beams for a serving cell of the plurality of serving cells is reported.

A bit (also referred to as a Bi bit) in the bitmap may be used to indicate whether the beam information is present for a serving cell of the plurality of serving cells. As an example, if the Bi=0, no additional beam information may be reported and if Bi=1, there may be at least one beam information for the serving cell.

In some example embodiments, the presence of the Bi-bitmap in the PHR may be determined in a number of ways. For example, the R-bit in the Ci bitmap may be used to indicate if the Bi-bitmap follows or not. This way, the Bi-bitmap may not be required to be signaled in case no beam information is reported for any serving cell. Legacy LCID for PHR maybe be used for the new PHR format.

Alternatively, the R-bit may not be used but remain reserved. In this case, a logical channel identity (LCID) may be used to indicate whether the beam information for the plurality of serving cells is present.

For example, the device 120 may send to the device 110 a configuration for using a LCID for sending the PHR when beam information is present for at least one of the plurality of serving cells. Accordingly, the 110 may receive the configuration from the device 120, and then use a LCID for sending the PHR when beam information is present for at least one of the plurality of serving cells. Alternatively, when additional beam information reporting is configured for at least one serving cell, the format for reporting additional beam is always used with the LCID different from legacy LCID for PHR. Alternatively, PHR formats with both LCIDs can be used and which one to use depends on whether there is beam information reported for at least one serving cell. In some example, LCID above may refer to eLCID as well.

Alternatively, the R-bit may be used to indicate beam information for a primary cell (PCell). In this case, the Bi-bitmap may be always included in the PHR. Alternatively, different LCID may be used to indicate whether Bi-bitmap is included or not as explained above.

In some example embodiments, the size of the bitmap for the beam information may be determined in a number of ways. For example, the bitmap for the beam information may have a fixed size. For example, if there are 8 serving cells, the bitmap for the beam information may have 1 octet. For example, if there are 32 serving cells, the bitmap for the beam information may have 4 octets.

In some example embodiments, one bit of Bi-bitmap is reserved, and beam information of C0 (Ci where i=0) is always present in the PHR report.

Alternatively, the bitmap for the beam information may only indicate the cells for which the beam information reporting is configured by the device 210. In this case, if less than 8 serving cells are configured to report the additional beam information, the bitmap for the beam information may have 1 octet. For example, if up to 32 serving cells are configured to report the additional beam information, the bitmap for the beam information may have 4 octets.

Alternatively, the size of bitmap for the beam information may be determined based on the highest serving cell index configured with additional beam information. If the highest serving cell index is smaller than 8, then the bitmap for the beam information may have 1 octet. Otherwise, it may have 4 octets.

Alternatively, the size of the bitmap for the beam information may be determined based on the number of activated serving cells. In this case, the size of the bitmap for the beam information may be determined based on the number of serving cells indicated to be reported by the Ci bitmap. That is, the size of the bitmap for the beam information may be determined based on the number of serving cells for which PH is configured to be reported.

Alternatively, the size of the bitmap for the beam information may be determined based on a combination of the above determination approaches.

In some example embodiments, when a bit in the bitmap indicates that beam information is present for a serving cell (also referred to as a first serving cell) of the plurality of serving cells, the PHR may further comprise beam information of the serving cell (also referred to as first beam information). In this case, an additional bit (also referred to as an extension, E, bit) in the first beam information for a serving cell may be used to indicate whether further beam information (also referred to as second beam information) is present for the serving cell. In this case, the E bit in the first beam information may be used to indicate whether the first beam information for the reported current beam is followed by the second beam information for another beam. As such, the device 120 may be allowed to distinguish where borders of beam information of the serving cell are. That is, the device 120 may be allowed to determine end of beam information of the serving cell.

In some example embodiments, the device 120 may send to the device 110 a configuration of the beam information reporting. For example, the configuration may comprise a maximum number of beams to be reported. Accordingly, the device 110 may receive the configuration of the beam information reporting from the device 120. As an example, the maximum number of additional beams to be reported may be 4. In this case, the number of beams to be reported for each of the plurality of serving cells may be configured by the device 120 respectively. That is, the number of beams for a serving cell to be reported may be different form or the same as another serving cell. In some example embodiments, the configuration may comprise one or more thresholds to trigger the report for beam information.

In some example embodiments, when a bit in the bitmap indicates that beam information is present for a first serving cell of the plurality of serving cells, the beam information of the first serving cell may further comprise a bit to indicate whether and/or how much P-MPR is required by the user device when using a beam of the first serving cell. For example, the beam information of the first serving cell may comprise a “MPE or R” field to indicate MPE of a beam of the first serving cell. For example, the beam information of the first serving cell may further comprise a “P_CMAX” field.

In some example embodiments, Bi-bitmap may not be included in the PHR. If Bi-bitmap may be not included in the PHR, one specific beam identity value in an octet may be reserved to indicate whether another any additional beam information is included. In this case, for example, one specific beam identity value may be used to indicate no additional beam information for the serving cell is included in the PHR.

In some example embodiments, for each serving cell for which the Bi-bitmap indicates that one or more beam information octets are reported, the PH octets of the serving cell may precede the one or more beam information octets.

In some example embodiments, when a bit in the bitmap indicates that beam information is present for a first serving cell of the plurality of serving cells, the beam information of the first serving cell may further comprise a field to indicate PH for the beam of the first serving cell. For example, the PH of the beam information of the first serving cell may be encoded to another byte reported for the beam or may be encoded instead of “P_CMAX” field. For example, the PH may be reported instead of “P_CMAX” field when no power backoff is required.

As shown in FIG. 2, the device 110 sends (210) a power headroom report, PHR, to the device 120. For example, the PHR comprises a bitmap indicating whether beam information for a plurality of serving cells is present.

In some example embodiments, the device 120 may send to the device 110 a configuration for conditions to trigger sending of the PHR when MPE for a beam is lower than a threshold amount or better than MPE for a serving beam, and/or quality of a beam is higher than threshold quality or better than quality of the serving beam. Accordingly, the device 110 may trigger the sending of PHR.

In some example embodiments, the device 110 may trigger the sending of the PHR when MPE for a beam is lower than a threshold amount or better than MPE for a serving beam. Alternatively, the device 110 may trigger the sending of the PHR when quality of a beam is higher than threshold quality or better than quality of the serving beam.

In some example embodiments, two TRPs (for example, TRP0 and TRP1) may be configured for a serving cell, and two Bi-bitmaps (called a first Bi-bitmap and a second Bi-bitmap) may be used to indicate whether beam information for each of the two TRPs of the serving cell are present. In this case, the first Bi-bitmap and the second Bi-bitmap may indicate separately the beam information reporting for each TRP.

In some example embodiments, for each serving cell, the device 120 may separately configure whether one or two TRP are used. For example, for each TRP, the number of beams to be reported may be configured by the device 120 respectively for different serving cells.

For example, the second Bi-bitmap may have the same size as the first Bi-bitmap. The size of the Bi-bitmap may be determined by the approaches mentioned above. For the purpose of simplification, the details will be omitted.

Alternatively, the second Bi-bitmap may be limited by the serving cells configured with multiple TRPs and/or mTRP based beam information reporting. In this case, the first Bi-bitmap may be only used to indicate the beam information for the serving cells configured with mTRP, while the second Bi-bitmap may be used to indicate beam information for the serving cells for which no mTRP is configured.

Alternatively, there is only one Bi-bitmap per serving cell and the bit for the serving cell is set to 1 as long as beam information is indicated for at least one of the TRPs. If no beam information is reported for the other TPR, a reserved beam ID is used to indicate no beam information for the TRP. The bit for the serving cell is set to 0 if no beam information is report for both TRPs.

Alternatively, no Bi-bitmap is used in the PHR to indicate beam information report. If no Bi-bitmap is comprised in the PHR, a specific beam ID may be reserved for indicating that no beam information available for the serving cell.

In some example embodiments, only a new PHR format may be used to report beam information for one of the two TRPs of each Serving Cell. In this case, the TRP may be encoded in the PHR as described above. That is, the first Bi-bitmap may be determined as specified above. The device 110 may then send also another PHR identified by a different LCID comprising solely the second Bi-bitmap as specified above and the beam information for each serving cell indicated.

In some example embodiments, for a single entry PHR format, another LCID (or eLCID) may be used to indicate that the PHR with beam information is being reported and the beam information reporting follows the principle as described above. In this case, no bitmap is required. This way, the R-bit may be preserved for future use and the nature of fixed size of the single entry PHR format may be also preserved.

FIG. 3 illustrates an example structure for PHR containing beam information according to some example embodiments of the present disclosure.

As shown in FIG. 3. There are 8 cells are configured. For example, the R-bit in the Ci-bitmap may be used to indicate if the Bi-bitmap follows or not. Alternatively, a LCID or eLCID may be used to indicate whether the beam information for the plurality of serving cells is present.

A Bi-bitmap is shown at 302. A bit in the Bi-bitmap 302 indicates whether beam information is present for a serving cell of the plurality of serving cells. For example, the beam information comprises P field, E field, beam index field, MPE field and P_CMAX field. The P field is used to indicate information associated with power backoff. The E field may be used to indicate presence of further beam information octets. The beam index field is used to indicate index of the beam. The MPE field used to indicate MPE of a beam. The P_CMAX field is used to indicate the maximum UE configured transmit power and used for calculation of the preceding PH field.

For example, beam information for a primary cell (also called serving cell 0) is shown at 304. The information for the primary cell comprises beam information for 4 beams of the primary cell. For example, E1-bit in the beam information for the first beam of the primary cell may indicate presence of beam information of the second beam. As an example, E field in the beam information of the fourth beam may be reserved because maximum 4 beams are allowed to be configured. Likewise, beam information for another serving cell (also called serving cell 1) is shown at 306.

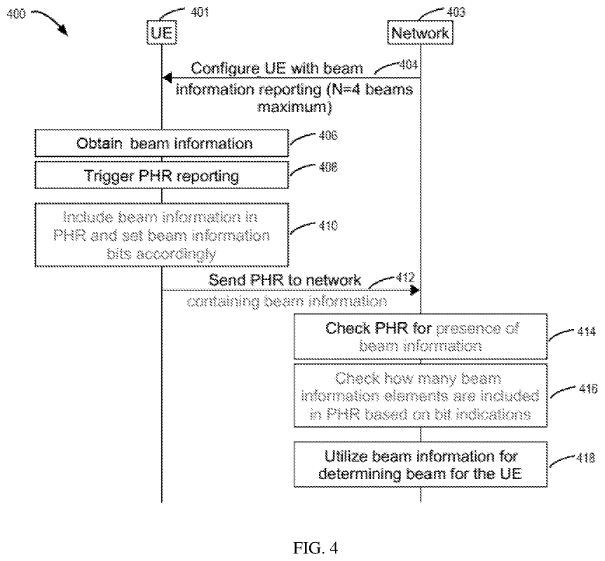

FIG. 4 illustrates an example process 400 for beam information reporting according to some example embodiments of the present disclosure. For the purpose of discussion, the process 400 will be described with reference to FIG. 1. For example, the device 110 is implemented by a UE 401 and the device 120 is implemented by a network device 403.

As shown in FIG. 4, at 404, the network device 403 may configure the UE 401 with beam information reporting. For example, the UE 401 may be configured to report beam information for no more than 4 beams. As an example, the network device 403 may send a configuration for conditions to trigger sending of the PHR when MPE for a beam is lower than a threshold amount or better than MPE for a serving beam, and/or quality of a beam is higher than threshold quality or better than quality of the serving beam.

At 406, the UE 401 may obtain beam information.

At 408, the UE 401 may trigger PHR reporting based on the configuration for conditions. In some example embodiments, the UE 401 may trigger PHR reporting when MPE for a beam is lower than a threshold amount or better than MPE for a serving beam and/or quality of a beam is higher than threshold quality or better than quality of the serving beam.

At 410, the UE 401 may include beam information in PHR and set beam information bit, for example, Bi-bitmap, accordingly.

Then, at 412, the UE 401 sends PHR containing beam information to the network device 403.

The network device 403 receives the PHR containing beam information and obtain beam information accordingly. The network device obtains the beam information for example according to 414 and 416.

At 414, the network device 403 may check PHR for presence of beam information, for example based on R-bit or a LCID or eLCID.

At 416, the network device 403 may check how many beam information elements are included in the PHR based on bit indications, for example at least based on Bi-bitmap and E-bit.

Then, at 418, the network device 403 may utilize beam information for determining the beam for the UE 401.

All operations and features as described above with reference to FIGS. 1-3 are likewise applicable to the process 400 and have similar effects. For the purpose of simplification, the details will be omitted.

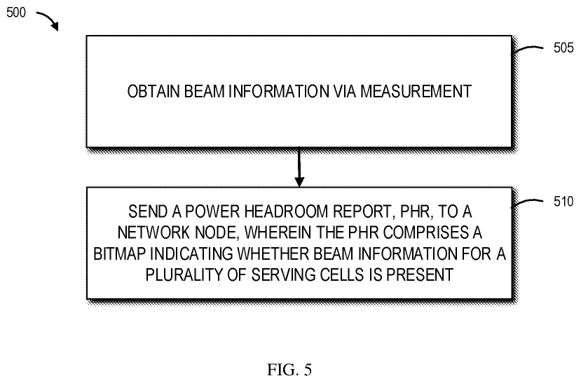

FIG. 5 shows a flowchart of an example method 500 according to some example embodiments of the present disclosure. The method 500 can be implemented at the device 110 as shown in FIG. 1. For the purpose of discussion, the method 500 will be described with reference to FIG. 1.

At block 505, the device 110 obtains beam information via measurement. At block 510, the device 110 sends a power headroom report, PHR, to the device 120. The PHR comprises a bitmap indicating whether beam information for a plurality of serving cells is present.

In some example embodiments, when a bit in the bitmap indicates that beam information is present for a first serving cell of the plurality of serving cells, the PHR further comprises first beam information of the first serving cell, wherein the first beam information comprises an extension, E, bit indicating whether second beam information is present for the serving cell.

In some example embodiments, when a bit in the bitmap indicates that beam information is present for a first serving cell of the plurality of serving cells, the beam information of the first serving cell further comprises a bit indicating whether and/or how much power management maximum power reduction, P-MPR, is required by the device 110 when using a beam of the first serving cell.

In some example embodiments, the device 110 may receive, from the device 120, a configuration of the beam information reporting. The configuration comprises a maximum number of beams to be reported.

In some example embodiments, the device 110 may trigger the sending of the PHR when maximum permission exposure, MPE, for a beam is lower than a threshold amount or better than MPE for a serving beam, and/or quality of a beam is higher than threshold quality or better than quality of the serving beam.

In some example embodiments, the device 110 may use a logical channel identity, LCID, for sending the PHR when beam information is present for at least one of the plurality of serving cells.

Those skilled in the art can understand that all operations and features as described above with reference to FIGS. 1-4 are likewise applicable to the method 500 and have similar effects.

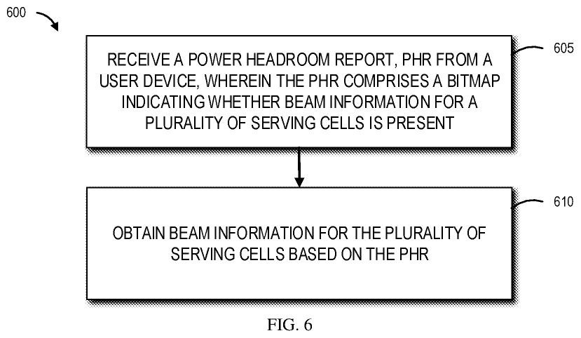

FIG. 6 shows a flowchart of an example method 600 according to some other example embodiments of the present disclosure. The method 600 can be implemented at the device 120 as shown in FIG. 1. For the purpose of discussion, the method 600 will be described with reference to FIG. 1.

At block 605, the device 120 receives a power headroom report, PHR from the device 110. The PHR comprises a bitmap indicating whether beam information for a plurality of serving cells is present. At block 610, the device 120 obtains beam information for the plurality of serving cells based on the PHR.

In some example embodiments, when a bit in the bitmap indicates that beam information is present for a first serving cell of the plurality of serving cells, the PHR further comprises first beam information of the first serving cell, wherein the first beam information comprises an extension, E, bit indicating whether second beam information is present for the serving cell.

In some example embodiments, when a bit in the bitmap indicates that beam information is present for a first serving cell of the plurality of serving cells, the beam information of the first serving cell further comprises a bit indicating whether and/or how much power management maximum power reduction, P-MPR, is required by the device 110 when using a beam of the first serving cell.

In some example embodiments, the device 120 may send to the device 110, a configuration of the beam information reporting. The configuration comprises a maximum number of beams to be reported.

In some example embodiments, the device 120 may send, to the device 110, a configuration for conditions to trigger sending of the PHR when maximum permission exposure, MPE, for a beam is lower than a threshold amount or better than MPE for a serving beam, and/or quality of a beam is higher than threshold quality or better than quality of the serving beam.

In some example embodiments, the device 120 may send, to the device 110, a configuration for using a logical channel identity, LCID, for sending the PHR when beam information is present for at least one of the plurality of serving cells.

Those skilled in the art can understand that all operations and features as described above with reference to FIGS. 1-4 are likewise applicable to the method 600 and have similar effects.

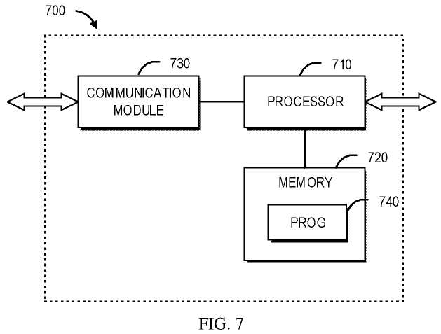

FIG. 7 is a simplified block diagram of a device 700 that is suitable for implementing example embodiments of the present disclosure. The device 700 can be implemented at or as a part of the device 110 or the device 120 as shown in FIG. 1.

As shown, the device 700 includes a processor 710, a communication module 730 communication module 730. The device 700 may further include a memory 720 coupled to the processor 710 coupled to the processor 710. The device 700 may further include a communication interface (not shown) coupled to the communication module 730. The memory 720 may store at least a program 740. The communication module 730 is for bidirectional communications, for example, via multiple antennas. The communication interface may represent any interface that is necessary for communication. The communication module 730 may for example be a transceiver.

The program 740 is assumed to include program instructions that, when executed by the associated processor 710, enable the device 700 to operate in accordance with the example embodiments of the present disclosure, as discussed herein with reference to FIGS. 1-6. The example embodiments herein may be implemented by computer software executable by the processor 710 of the device 700, or by hardware, or by a combination of software and hardware. The processor 710 may be configured to implement various example embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

When the device 700 acts as the device 110 or a part of the device 110, the processor 710 and the communication module 730 may cooperate to implement the method 500 as described above with reference to FIGS. 1-4. When the device 700 acts as the device 120 or a part of the device 120, the processor 710 and the communication module 730 may cooperate to implement the method 600 as described above with reference to FIGS. 1-4. All operations and features as described above with reference to FIGS. 1-6 are likewise applicable to the device 700 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIGS. 1-4. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: obtaining, by a user device, beam information via measurement; and sending, by a user device, a power headroom report, PHR, to a network node, wherein the PHR comprises a bitmap indicating whether beam information for a plurality of serving cells is present.

In some example embodiments, when a bit in the bitmap indicates that beam information is present for a first serving cell of the plurality of serving cells, the PHR further comprises first beam information of the first serving cell, wherein the first beam information comprises an extension, E, bit indicating whether second beam information is present for the serving cell.

In some example embodiments, when a bit in the bitmap indicates that beam information is present for a first serving cell of the plurality of serving cells, the beam information of the first serving cell further comprises a bit indicating whether and/or how much power management maximum power reduction, P-MPR, is required by the user device when using a beam of the first serving cell.

In some example embodiments, the method further comprises: receiving, by the user device and from the network node, a configuration of the beam information reporting, wherein the configuration comprises a maximum number of beams to be reported.

In some example embodiments, sending the PHR to the network device comprises: triggering, by the user device, the sending of the PHR when maximum permission exposure, MPE, for a beam is lower than a threshold amount or better than MPE for a serving beam, and/or quality of a beam is higher than threshold quality or better than quality of the serving beam.

In some example embodiments, the method further comprises: using, by the user device, a logical channel identity, LCID, for sending the PHR when beam information is present for at least one of the plurality of serving cells.

In some aspects, a method comprises: receiving, by a network node, a power headroom report, PHR from a user device, wherein the PHR comprises a bitmap indicating whether beam information for a plurality of serving cells is present; and obtaining beam information for the plurality of serving cells based on the PHR.

In some example embodiments, when a bit in the bitmap indicates that beam information is present for a first serving cell of the plurality of serving cells, the PHR further comprises first beam information of the first serving cell, wherein the first beam information comprises an extension, E, bit indicating whether second beam information is present for the serving cell.

In some example embodiments, when a bit in the bitmap indicates that beam information is present for a first serving cell of the plurality of serving cells, the beam information of the first serving cell further comprises a bit indicating whether and/or how much power management maximum power reduction, P-MPR, is required by the user device when using a beam of the first serving cell.

In some example embodiments, the method further comprises: sending, by the network node and to the user device, a configuration of the beam information reporting, wherein the configuration comprises a maximum number of beams to be reported.

In some example embodiments, the method further comprises: sending, by the network node and to the user device, a configuration for conditions to trigger sending of the PHR when maximum permission exposure, MPE, for a beam is lower than a threshold amount or better than MPE for a serving beam, and/or quality of a beam is higher than threshold quality or better than quality of the serving beam.

In some example embodiments, the method further comprises: sending, by the network node and to the user device, a configuration for using a logical channel identity, LCID, for sending the PHR when beam information is present for at least one of the plurality of serving cells.

In some aspects, an apparatus comprises: a transceiver and at least one processor; wherein the at least one processor is configured to: obtain beam information via measurement; and the transceiver is configured to send a power headroom report, PHR, to a network node, wherein the PHR comprises a bitmap indicating whether beam information for a plurality of serving cells is present.

In some example embodiments, when a bit in the bitmap indicates that beam information is present for a first serving cell of the plurality of serving cells, the PHR further comprises first beam information of the first serving cell, wherein the first beam information comprises an extension, E, bit indicating whether second beam information is present for the serving cell.

In some example embodiments, when a bit in the bitmap indicates that beam information is present for a first serving cell of the plurality of serving cells, the beam information of the first serving cell further comprises a bit indicating whether and/or how much power management maximum power reduction, P-MPR, is required by the user device when using a beam of the first serving cell.

In some example embodiments, the apparatus is further caused to receive, from the network node, a configuration of the beam information reporting, wherein the configuration comprises a maximum number of beams to be reported.

In some example embodiments, the at least one processor is configured to: trigger the sending of the PHR when maximum permission exposure, MPE, for a beam is lower than a threshold amount or better than MPE for a serving beam, and/or quality of a beam is higher than threshold quality or better than quality of the serving beam.

In some example embodiments, the at least one processor is further configured to: use a logical channel identity, LCID, for sending the PHR when beam information is present for at least one of the plurality of serving cells.

In some aspects, an apparatus comprises: a transceiver and at least one processor; wherein the transceiver is configured to: receive a power headroom report, PHR from a user device, wherein the PHR comprises a bitmap indicating whether beam information for a plurality of serving cells is present; and the at least one processor is configured to obtain beam information for the plurality of serving cells based on the PHR.

In some example embodiments, when a bit in the bitmap indicates that beam information is present for a first serving cell of the plurality of serving cells, the PHR further comprises first beam information of the first serving cell, wherein the first beam information comprises an extension, E, bit indicating whether second beam information is present for the serving cell.

In some example embodiments, when a bit in the bitmap indicates that beam information is present for a first serving cell of the plurality of serving cells, the beam information of the first serving cell further comprises a bit indicating whether and/or how much power management maximum power reduction, P-MPR, is required by the user device when using a beam of the first serving cell.

In some example embodiments, the transceiver is further configured to send, to the user device, a configuration of the beam information reporting, wherein the configuration comprises a maximum number of beams to be reported.

In some example embodiments, the at least one processor is further configured to: send, to the user device, a configuration for conditions to trigger sending of the PHR when maximum permission exposure, MPE, for a beam is lower than a threshold amount or better than MPE for a serving beam, and/or quality of a beam is higher than threshold quality or better than quality of the serving beam.

In some example embodiments, the transceiver is further configured to: send, to the user device, a configuration for using a logical channel identity, LCID, for sending the PHR when beam information is present for at least one of the plurality of serving cells.

In some aspects, a computer readable storage medium comprises program instructions stored thereon, the instructions, when executed by a processor of a device, causing the device to perform the method according to some example embodiments of the present disclosure.

1-20. (canceled)

21. A method, comprising:
obtaining, by a user device, beam information via measurement; and
sending, by a user device, a power headroom report, to a network node, wherein the power headroom report comprises a bitmap indicating whether beam information for a plurality of serving cells is present.

22. The method according to claim 21, when a bit in the bitmap indicates that beam information is present for a first serving cell of the plurality of serving cells, the power headroom report further comprises first beam information of the first serving cell, wherein the first beam information comprises an extension bit indicating whether second beam information is present for the serving cell.

23. The method according to claim 21, when a bit in the bitmap indicates that beam information is present for a first serving cell of the plurality of serving cells, the beam information of the first serving cell further comprises a bit indicating whether and/or how much power management maximum power reduction is required by the user device when using a beam of the first serving cell.

24. The method according to claim 21, further comprising:
receiving, by the user device and from the network node, a configuration of the beam information reporting, wherein the configuration comprises a maximum number of beams to be reported.

25. The method according to claim 21, wherein sending the power headroom report to the network device comprises:
triggering, by the user device, the sending of the power headroom report when:
maximum permission exposure for a beam is lower than a threshold amount or better than maximum permission exposure for a serving beam, and/or
quality of a beam is higher than threshold quality or better than quality of the serving beam.

26. The method according to claim 21, further comprising:
using, by the user device, a logical channel identity for sending the power headroom report when beam information is present for at least one of the plurality of serving cells.

27. An apparatus comprising:
at least one processor; and
at least one memory including computer program code;
the at least one memory and the computer program code configured to, with the at least one processor, cause the apparatus at least to:
receive a power headroom report from a user device, wherein the power headroom report comprises a bitmap indicating whether beam information for a plurality of serving cells is present; and
obtain beam information for the plurality of serving cells based on the power headroom report.

28. The apparatus according to claim 27, when a bit in the bitmap indicates that beam information is present for a first serving cell of the plurality of serving cells, the power headroom report further comprises first beam information of the first serving cell, wherein the first beam information comprises an extension bit indicating whether second beam information is present for the serving cell.

29. The apparatus according to claim 27, when a bit in the bitmap indicates that beam information is present for a first serving cell of the plurality of serving cells, the beam information of the first serving cell further comprises a bit indicating whether and/or how much power management maximum power reduction is required by the user device when using a beam of the first serving cell.

30. The apparatus according to claim 27, wherein the apparatus is further caused to:
send, to the user device, a configuration of the beam information reporting, wherein the configuration comprises a maximum number of beams to be reported.

31. The apparatus according to claim 27, wherein the apparatus is further caused to:
send, to the user device, a configuration for conditions to trigger sending of the power headroom report when:
maximum permission exposure for a beam is lower than a threshold amount or better than maximum permission exposure for a serving beam, and/or
quality of a beam is higher than threshold quality or better than quality of the serving beam.

32. The apparatus according to claim 27, wherein the apparatus is further caused to:
send, to the user device, a configuration for using a logical channel identity for sending the power headroom report when beam information is present for at least one of the plurality of serving cells.

33. An apparatus, comprising:
at least one processor; and
at least one memory including computer program code;
the at least one memory and the computer program code configured to, with the at least one processor, cause the apparatus at least to:
obtain beam information via measurement; and
send a power headroom report to a network node, wherein the power headroom report comprises a bitmap indicating whether beam information for a plurality of serving cells is present.

34. The apparatus according to claim 33, when a bit in the bitmap indicates that beam information is present for a first serving cell of the plurality of serving cells, the power headroom report further comprises first beam information of the first serving cell, wherein the first beam information comprises an extension, bit indicating whether second beam information is present for the serving cell.

35. The apparatus according to claim 33, when a bit in the bitmap indicates that beam information is present for a first serving cell of the plurality of serving cells, the beam information of the first serving cell further comprises a bit indicating whether and/or how much power management maximum power reduction, is required by the apparatus when using a beam of the first serving cell.

36. The apparatus according to claim 33, wherein the apparatus is further caused to:
receive, from the network node, a configuration of the beam information reporting, wherein the configuration comprises a maximum number of beams to be reported.

37. The apparatus according to claim 33, wherein the apparatus is further caused to:
trigger the sending of the power headroom report when:
maximum permission exposure for a beam is lower than a threshold amount or better than maximum permission exposure for a serving beam, and/or
quality of a beam is higher than threshold quality or better than quality of the serving beam.

38. The apparatus according to claim 33, wherein the apparatus is further caused to:
use a logical channel identity for sending the power headroom report when beam information is present for at least one of the plurality of serving cells.
